(19) United States
(12) Patent Application Publication
(10) Pub. No.: US 2008/0201261 A1
(43) Pub. Date: Aug. 21, 2008

(54) SYSTEM AND METHOD FOR ELECTRONIC PAYMENT PROCESSING

(76) Inventors: Benjamin Vides, Coral Gables, FL (US); Brian Downey, Alexandria, VA (US)

Correspondence Address: BLANK ROME LLP, 600 NEW HAMPSHIRE AVENUE, N.W., WASHINGTON, DC, 20037, US

(21) Appl. No.: 12/015,239

(22) Filed: Jan. 16, 2008

Related U.S. Application Data
(60) Provisional application No. 60/885,176, filed on Jan. 16, 2007.

(51) Int. Cl. G06Q 20/00

(52) U.S. Cl. 705/44

(57) ABSTRACT

A method for electronically processing payments made to a plurality of merchants in a plurality of payment modes includes: (a) receiving information on the payments into a server; (h) processing the information into an automated clearinghouse file; (c) validating the automated clearinghouse file; and (d) sending the automated clearinghouse file from the server to an automated clearinghouse. Fraud is reduced, and rules are simplified and standardized.

### REFERENCE TO RELATED APPLICATION

The present application claims the benefit of U.S. Provisional Patent Application No. 60/885,176 (Confirmation No. 5304), filed Jan. 16, 2007, titled “System and Method for Electronic Payment Processing,” whose disclosure is hereby incorporated by reference in its entirety into the present disclosure.

### FIELD OF THE INVENTION

The present invention is directed to the processing of payments from a payer to a payee.

### DESCRIPTION OF RELATED ART

Businesses receive payments in a variety of formats, including checks sent through the mail, payments over the Internet, payments made through call centers, and payments through an IVR (interactive voice response) system. Those payments must be cleared, typically through an automated clearing house (ACH).

Rules are applied to determine whether a payment may be fraudulent or otherwise problematic. For example, information submitted in a payment may refer to a closed bank account. Those rules have traditionally been applied at the point of capture of the payment. As a consequence, each point of capture is burdened with devising its own rules, and the rules across various points of capture may be inconsistent.

Often, a merchant did not know that a payment was problematic until it was returned for insufficient funds, a closed bank account, a draft by someone other than the account owner, or another problem. There was often no way to manage such risks proactively.

Another problem was that the information regarding the payment was limited to an identification of a payee. When the payer received the statement, a person reviewing the statement might not recall the purpose of the payment and would therefore contest the payment erroneously but in good faith.

Still another concern was that a payee might want to establish sub-accounts, each with its own settlement account for receiving payments. For example, a collection agency might want to establish an account in trust for each creditor and to have each payment routed automatically to the appropriate account in trust. There was traditionally no effective way to do so. Moreover, payment rules and characteristics would have to be established for each sub-account separately.

Yet another concern was the time delay in reporting problems with payments. A bank would have to contact a merchant by a facsimile or telephone call, thus introducing a time delay.

### SUMMARY OF THE INVENTION

It is therefore an object of at least some embodiments of the invention to centralize the application of such rules.

It is another object of at least some embodiments of the invention to centralize the application of such rules for payments captured in various manners.

It is still another object of at least some embodiments of the invention to reduce fraud by allowing better and more timely information regarding problematic payments.

It is yet another embodiment of at least some embodiments of the invention to allow the formation and management of sub-merchant accounts.

To achieve the above and other object, the present invention is directed to a method for electronically processing payments made to a plurality of merchants in a plurality of payment modes, the method comprising: (a) receiving information on the payments into a server; (b) processing the information into an automated clearinghouse file; (c) validating the automated clearinghouse file; and (d) sending the automated clearinghouse file from the server to an automated clearinghouse.

The present invention offers the advantages of reducing fraud and permitting an integrated payment system. The rules no longer have to be applied at the point of capture. Instead, the invention allows a centralized system for payments captured from different payment modes. It is no longer required to program rules into each payment capture application; instead, they can be implemented centrally and pushed out to each capture application.

As for reduction of fraud, the rules allow a merchant to receive information to establish risk parameters. Otherwise, the merchant would have to wait until a payment was returned for whatever reason. A merchant can make decisions based on return data and proactively manage risks.

The invention allows the implementation of a single automated clearinghouse (ACH) file configuration that dovetails with the fraud reduction. The rules can be applied centrally. Also, by inclusion of information identifying a payment, the file permits the payees to identify payments and thus reduce the incidence of erroneous returns. The merchants can manage exceptions in the front end rather than in the back end of such returns.

The management of the rules can be hierarchical, from a global administrator to a processor to a merchant to a sub-merchant. Payment processing characteristics can be established top-down. Alternatively, they can be customized for each level.

Payments are often itemized, while a bank may pay in a lump sum. The money can be disbursed automatically into each desired account.

As for risk management, warnings and errors can be displayed on a review screen. Users can see warnings at all levels. Thus, the time lag while a bank informs a merchant of a bad payment can be reduced or eliminated.

Payments of diverse types can be handled. The payment information is normalized into a standard format for processing. Even unknown formats can be handled through wizards that recognize such information as bank routing numbers. Traditionally, a bank had to provide software to allow others to interface with its system.

An API can be provided to validate payments are they are entered.

A single merchant may with to set up multiple sub-merchants, each with its own settlement account. The present invention accommodates that ability.

### BRIEF DESCRIPTION OF THE DRAWINGS

Preferred embodiments of the present invention will be set forth in detail with reference to the drawings, in which:

FIGS. 1 and 2 are flow charts of a preferred embodiment;

FIG. 3 shows an exemplary set of portal user interactions;

FIG. 4 is a state diagram;

FIG. 5 shows an input screen display;

FIGS. 6-9 show a user interface for configuring rules;

FIGS. 10-16 show a user interface for a template-type user adaptive system for converting data of both known and unknown configurations; and

FIG. 17 shows an example of hardware on which the preferred embodiments can be implemented.

### DETAILED DESCRIPTION OF THE PREFERRED EMBODIMENTS

The present invention will be described in terms of one or more examples, with reference to the accompanying drawings. In the drawings, some like reference numbers indicate identical or functionally similar elements. Additionally, the left-most digit(s) of most reference numbers may identify the drawing in which the reference numbers first appear.

The present invention will be explained in terms of exemplary embodiments. This specification discloses one or more embodiments that incorporate the features of this invention. The disclosure herein will provide examples of embodiments, including examples of data analysis from which those skilled in the art will appreciate various novel approaches and features developed by the inventors. These various novel approaches and features, as they may appear herein, may be used individually, or in combination with each other as desired.

In particular, the embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, persons skilled in the art may effect such feature, structure, or characteristic in connection with other embodiments whether or not explicitly described.

Embodiments of the invention may be implemented in hardware, firmware, software, or any combination thereof, or may be implemented without automated computing equipment. Embodiments of the invention may also be implemented as instructions stored on a machine-readable medium, which may be read and executed by one or more processors. A machine-readable medium may include any mechanism for storing or transmitting information in a form readable by a machine (e.g. a computing device). For example, a machine-readable medium may include read only memory (ROM); random access memory (RAM); hardware memory in PDAs, mobile telephones, and other portable devices; magnetic disk storage media; optical storage media; flash memory devices; electrical, optical, acoustical, or other forms of propagated signals (e.g. carrier waves, infrared signals, digital signals, analog signals, etc.), and others. Further, firmware, software, routines, instructions, may be described herein as performing certain actions. However, it should be appreciated that such descriptions are merely for convenience and that such actions in fact result from computing devices, processors, controllers or other devices executing the firmware, software, routines, instructions, etc.

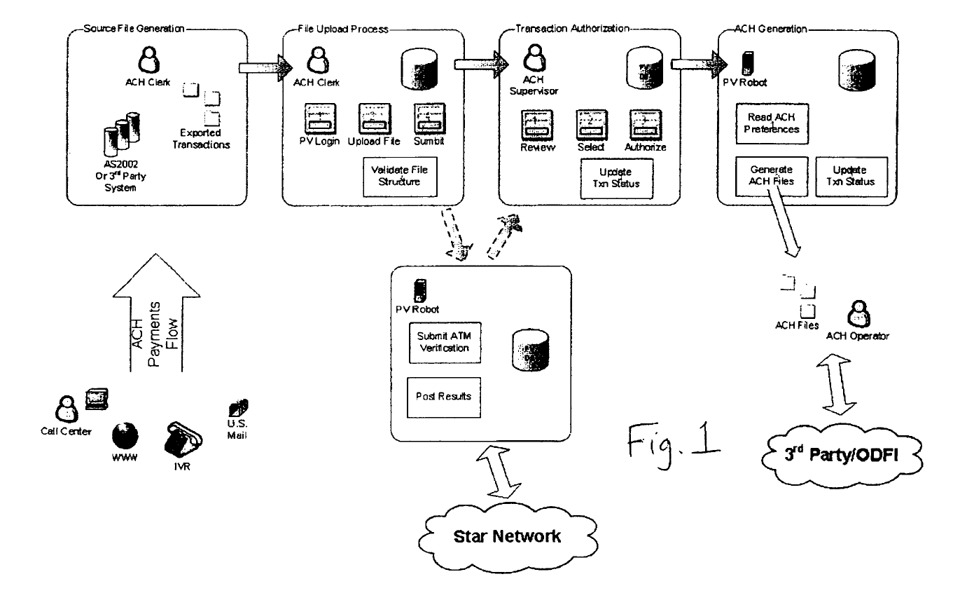

In a preferred embodiment, an electronic payment processing system receives payment information from payees and electronically generates and transmits data in a format that can be processed by an Automated Clearing House (ACH). An exemplary flow diagram for one embodiment of such a system is shown in FIG. 1. Payment orders are generated by call centers, web input, interactive voice response, mail, and the like. Source files are then generated by manual input, external processing systems, or exported transaction files. The file upload process then proceeds through optional validations by a “robot” program and/or a validation process provided by an external network available by subscription, e.g. the “Star Network” validation process. The file is then reviewed and authorized by a supervisor prior to ACH generation and submission.

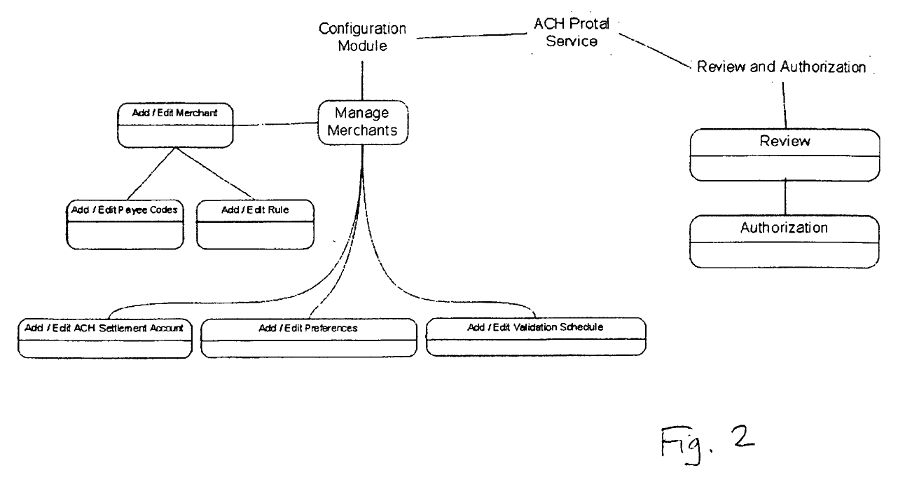

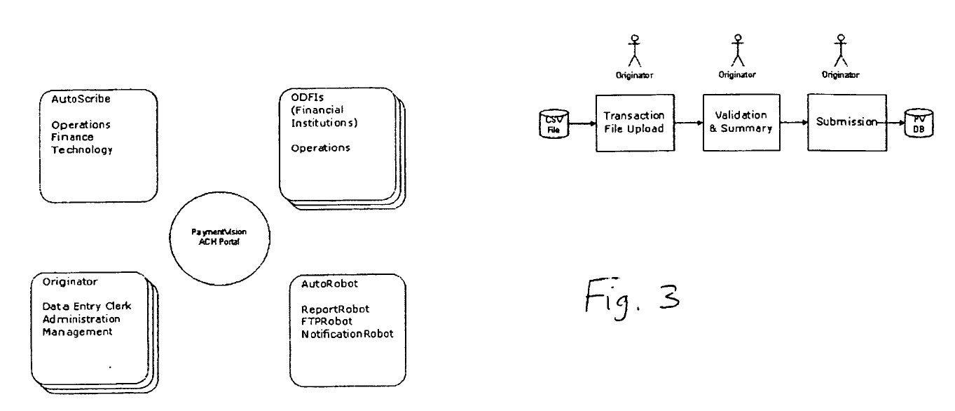

An exemplary embodiment of a process flow for ACH transaction setup and review processes is shown in FIG. 2. FIG. 3 is a diagram of an exemplary set of portal user interactions with originators, financial institutions, the operator (shown as AutoScribe™) and automatic robot processes.

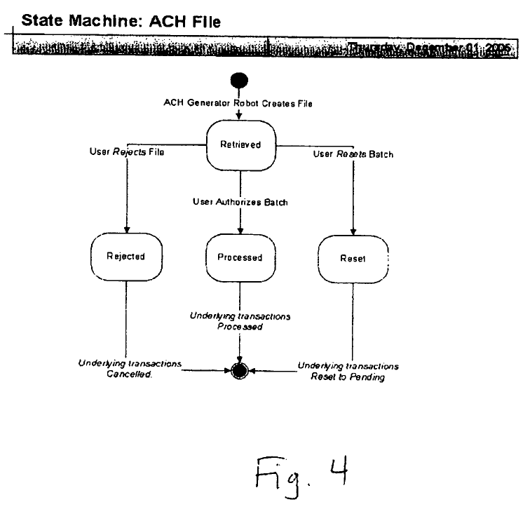

FIG. 4 shows a state diagram for processing of an ACH file in an exemplary process encompassed by the present invention. An ACH generator robot creates a file that is then retrieved by a user for review. The user reviews the file, reviews any exceptions reported, and may then reject the file, authorize submission of the batch, or reset the batch. The underlying transactions in the file will be cancelled, processed, or reset to pending based on the action of the user.

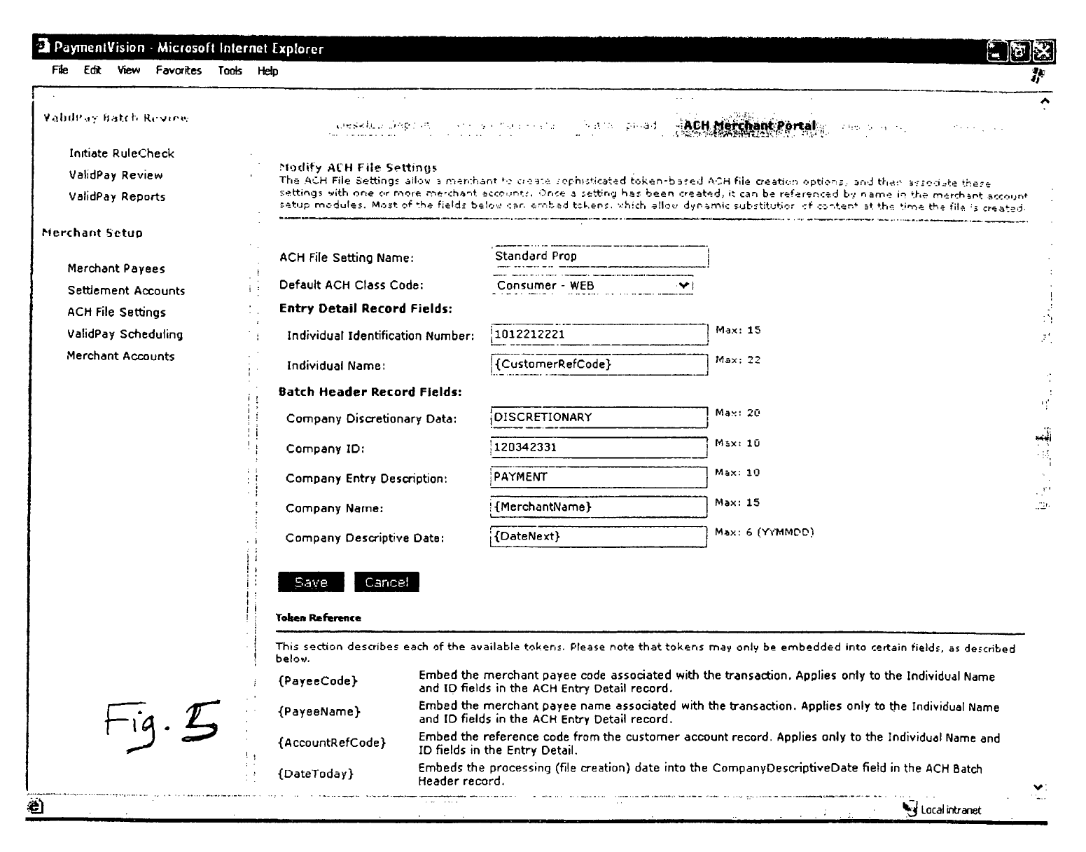

In certain embodiments, the software is provided with a token-based system for dynamically setting parameters in an ACH file. In traditional systems, static values are set for these parameters. In embodiments including dynamic parameter setting, upon generation of a data batch file for an ACH process, a token or variable identifier can be put in the file, to be replaced dynamically by actual data specific to the transaction as the batch file is processed. The token is a place holder for a value to be substituted during actual processing of a transaction. For example, when batch files are generated for processing, the merchant can dynamically include information specific to the transaction in a description field which will be displayed on the payer's bank statement. FIG. 5 shows an input screen display permitting configuration and operation of an exemplary token based system as described herein.

In conventional systems, this description field typically displays the name of the payee. The inventors have found that including additional details or identifiers for each transaction helps refresh the memory of the payer regarding his or her approval of the transaction. This reduces problems with payers returning legitimate transactions because the descriptive information provided does not include the trade name of the merchant, or other useful information that will cause them to remember the transaction.

In further embodiments, the system provides a hierarchy of merchant accounts set up so that merchants and affiliated sub-merchant accounts can be easily configured to inherit characteristics of the main merchant account or to have customized characteristics as needed. Typically, a merchant user of the system may have affiliates or sub-merchants to which different rules and configurations apply. To provide maximum flexibility without requiring repetitive setup for a large number of sub-merchants, a global administrator function is provided for specifying which setup fields are centrally determined master fields and which may be configured individually for each subaccount.

Preferably, common setup characteristics can be specified once in a main configuration. The sub-merchants inherit master values in a specified group of fields from the parent merchant configuration file. In an embodiment, if a parent merchant selects a configuration and a “child” or sub-merchant does not select a configuration, the submerchant preferably defaults to the parent configuration.

As an example, the dynamic tokens described previously can be managed for each sub-merchant individually. As another example, for a merchant with five sub-merchant accounts, two may select a special configuration while the remaining three, having common operating characteristics, subscribe to or select a standard or “main” ACH configuration for the merchant. As another example, flexible configuration can be applied to ACH settlement accounts, with the main merchant having more than one settlement account and each submerchant assigned to a particular desired settlement account.

A hierarchical account system is useful in some embodiments of the invention. This is an example implementation and is merely one example of how such systems can be implemented within the scope of the present invention.

In another embodiment, the system may be configured to allow multiple rule authors to create and view transactional risk assessment parameters and user-defined actions taken based on those parameters. A rule author may typically be a merchant or licensed processor serving merchants. Rule authors may be established at multiple levels-for example, a global level for a system operator serving multiple processors, a processor level for processors serving multiple merchants a merchant level, and a sub-merchant level.

Risk assessment parameters are established to limit the characteristics of transactions and to provide either a warning or an outright rejection of a transaction if it does not conform to expected parameters. For example, a merchant or a processor may establish a rule that no transaction for that merchant may exceed $1,000,000, or that for a particular submerchant account where all transactions are performed through the web, that no “TEL” class (telephone-authorized transactions) are permitted. A rule can be established at a global level, at the processor level, at a merchant level, or at a sub-merchant level, and rules applicable to entities at a particular rule level may be selectively excluded for particular entities. The user-defined actions in response to violation of a rule are typically either to provide a warning, or to define the violation as an error and reject the transaction. A warning can be overridden by supervisory personnel, but an error violation cannot be overridden.

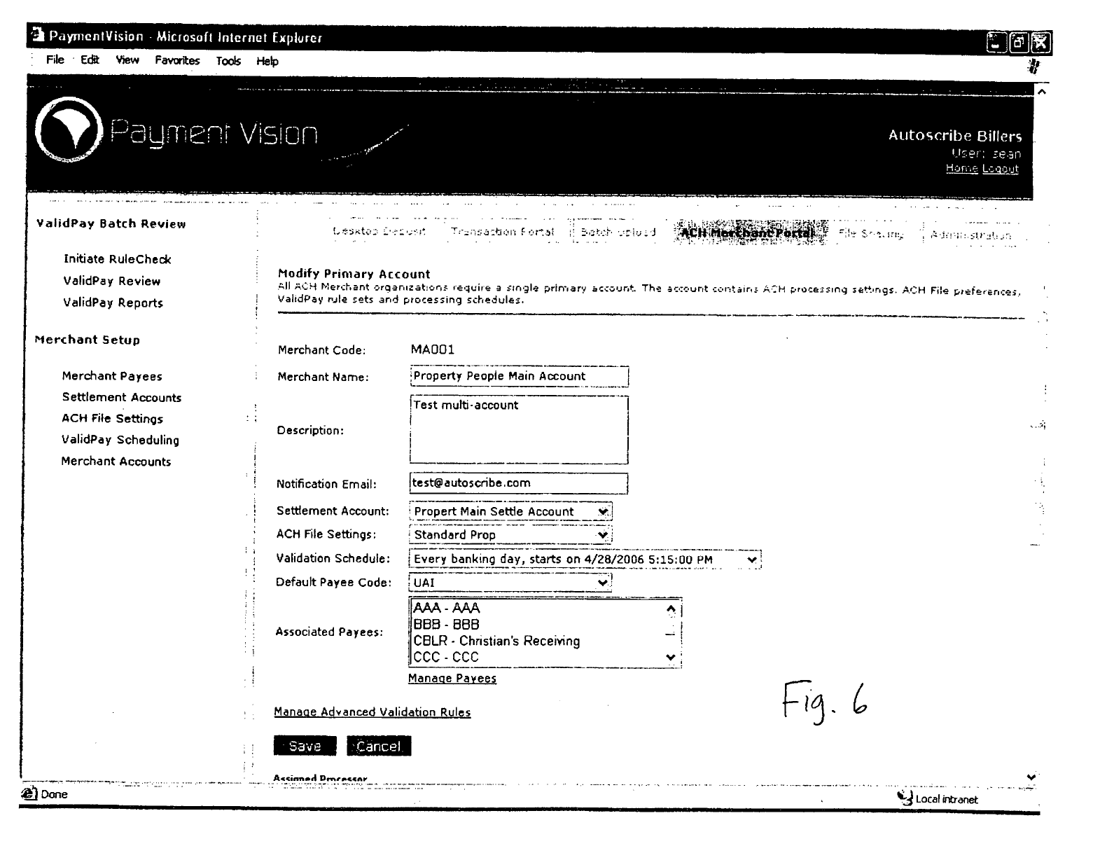

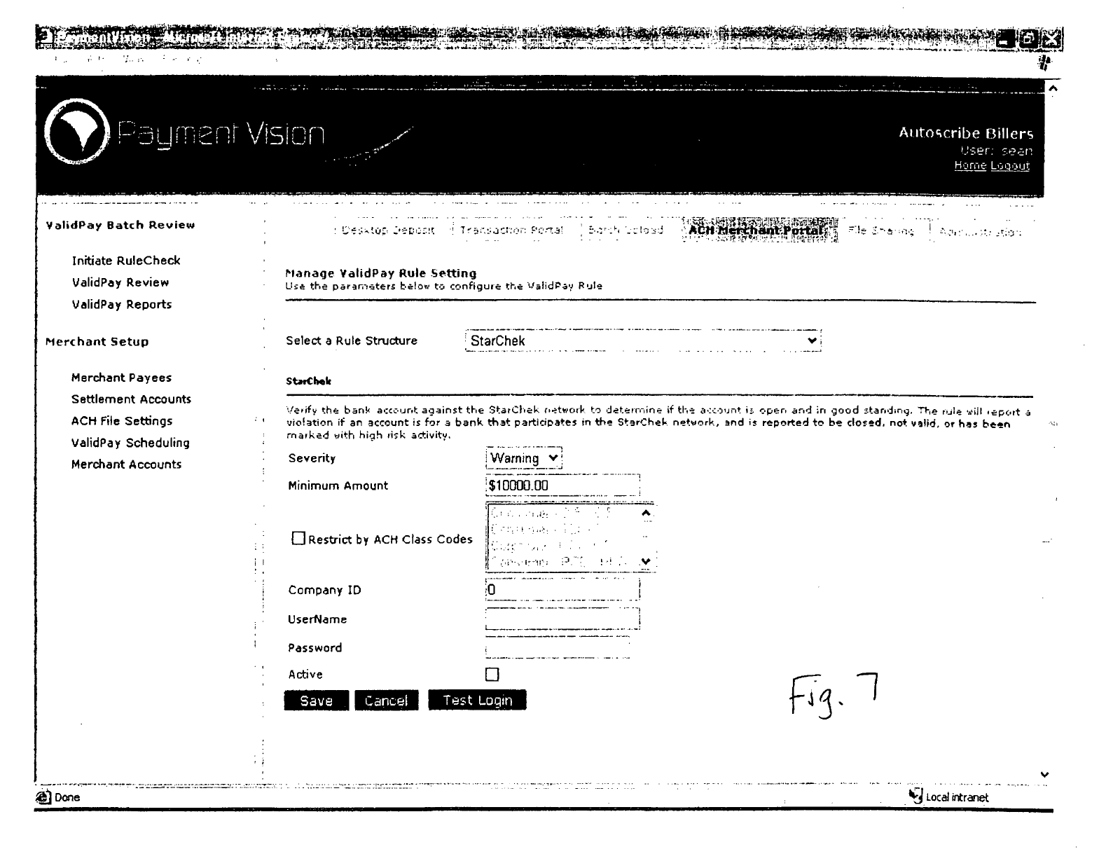

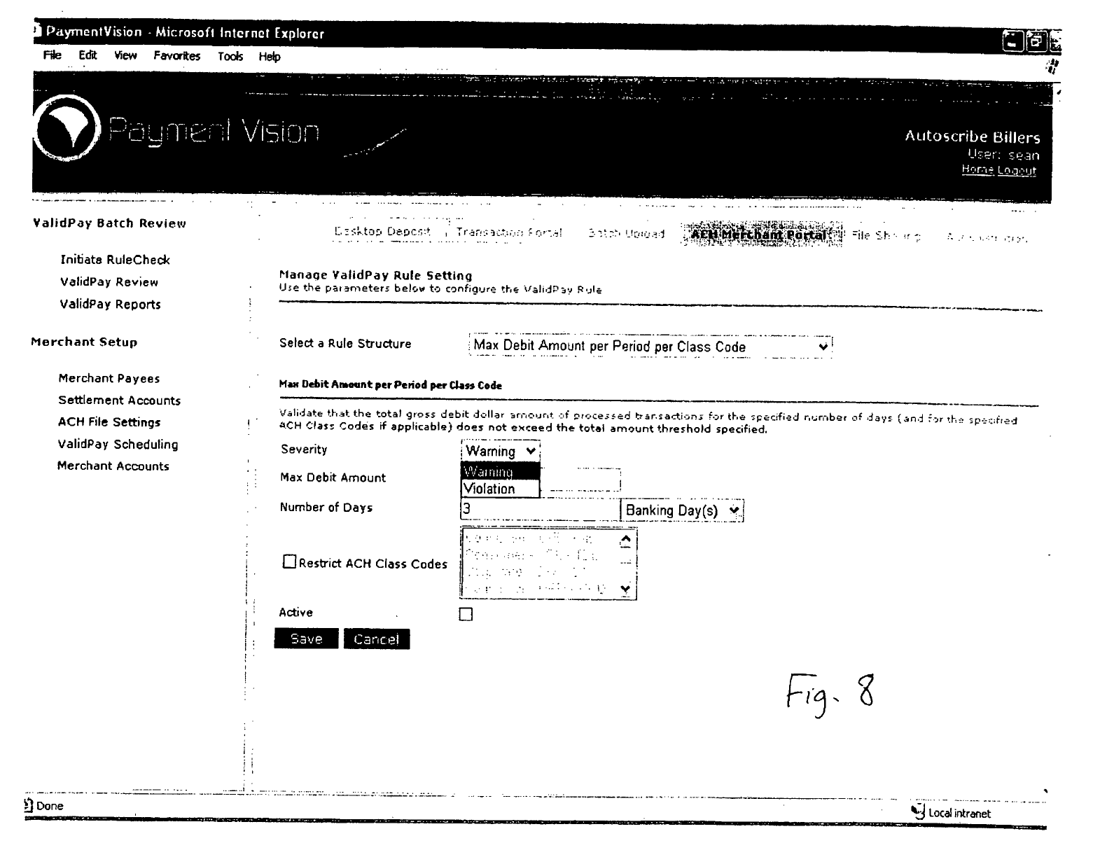

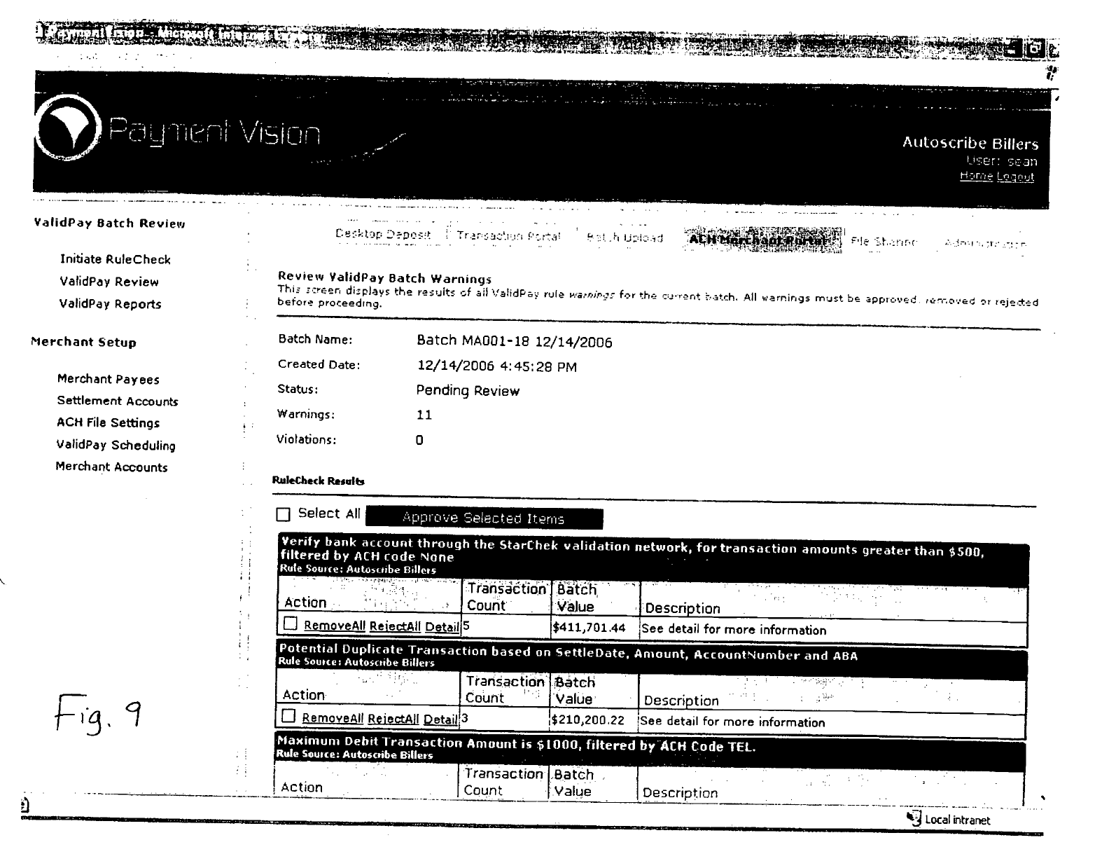

An exemplary user interface for configuring rules in the system and processing batches is shown in FIGS. 6-9. FIG. 6 shows a primary account rules management interface. FIG. 7 shows a screen for managing a rule setting. FIG. 8 shows another exemplary rule configuration screen for a merchant or sub-merchant. FIG. 9 shows an interface screen for supervisory review of “warning” transactions flagged by the system, which can be approved, rejected, or removed by the supervisor using this input screen. Processing rules may be created and selectively implemented at any of the established control levels in the system.

In a further embodiment, the system may include a process for providing a template-type user adaptive system that converts data of both known and unknown configurations into payment instructions. This processing method provides a “wizard” interface for receiving data from other systems and converting the data into usable transaction records. This facilitates an ability to process payments generated by legacy merchant systems and a variety of other vendor systems. The wizard is configurable to identify relevant fields in any order, with any delimiter. The input file is transformed into a payment instruction by having an operator or an automated process validate a correlation between data in specific fields and the fields needed for a payment instruction. For example, date fields are validated as having a date format, ABA number fields are validated as conforming to a known algorithm for such numbers and as representing a valid institution, transaction class codes are verified, and amount of transaction fields are validated as having an appropriate numeric format.

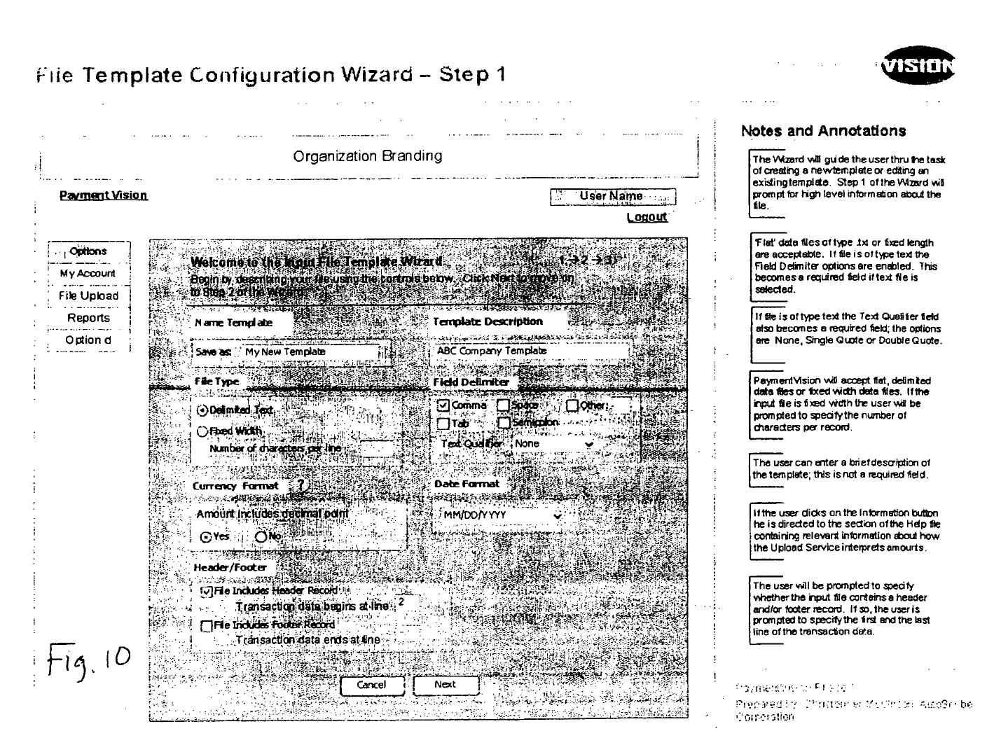

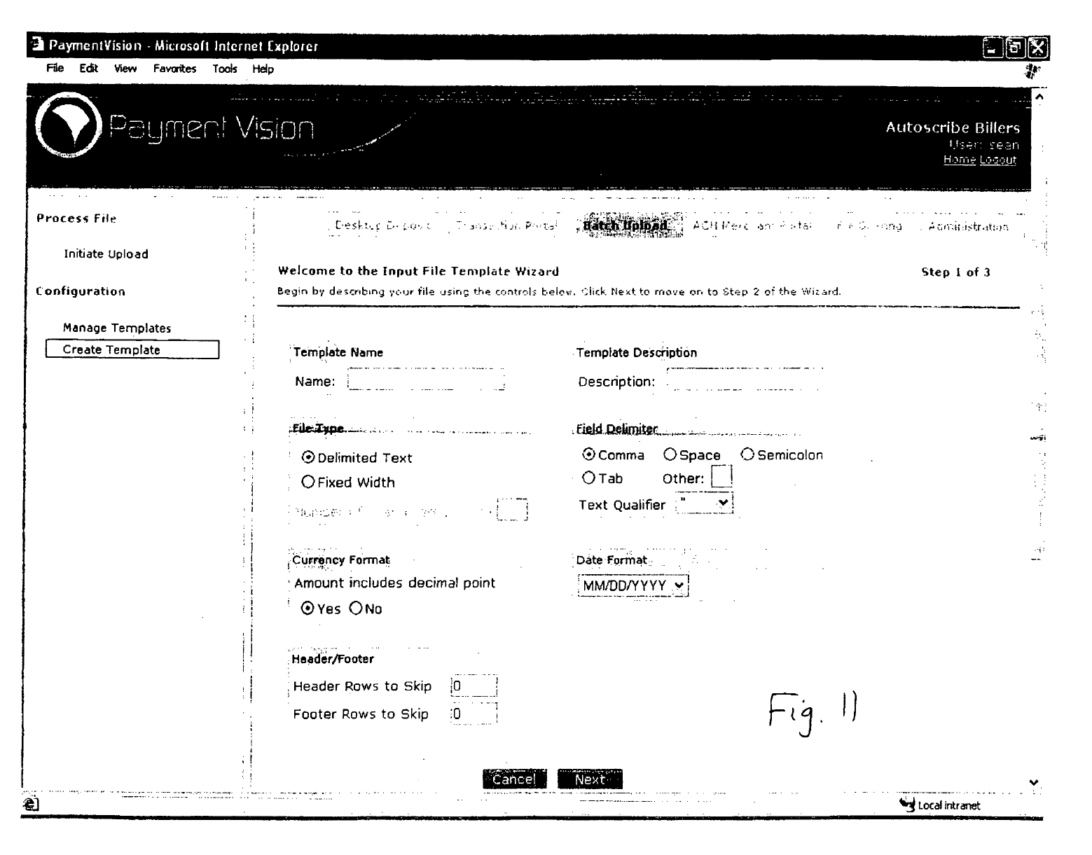

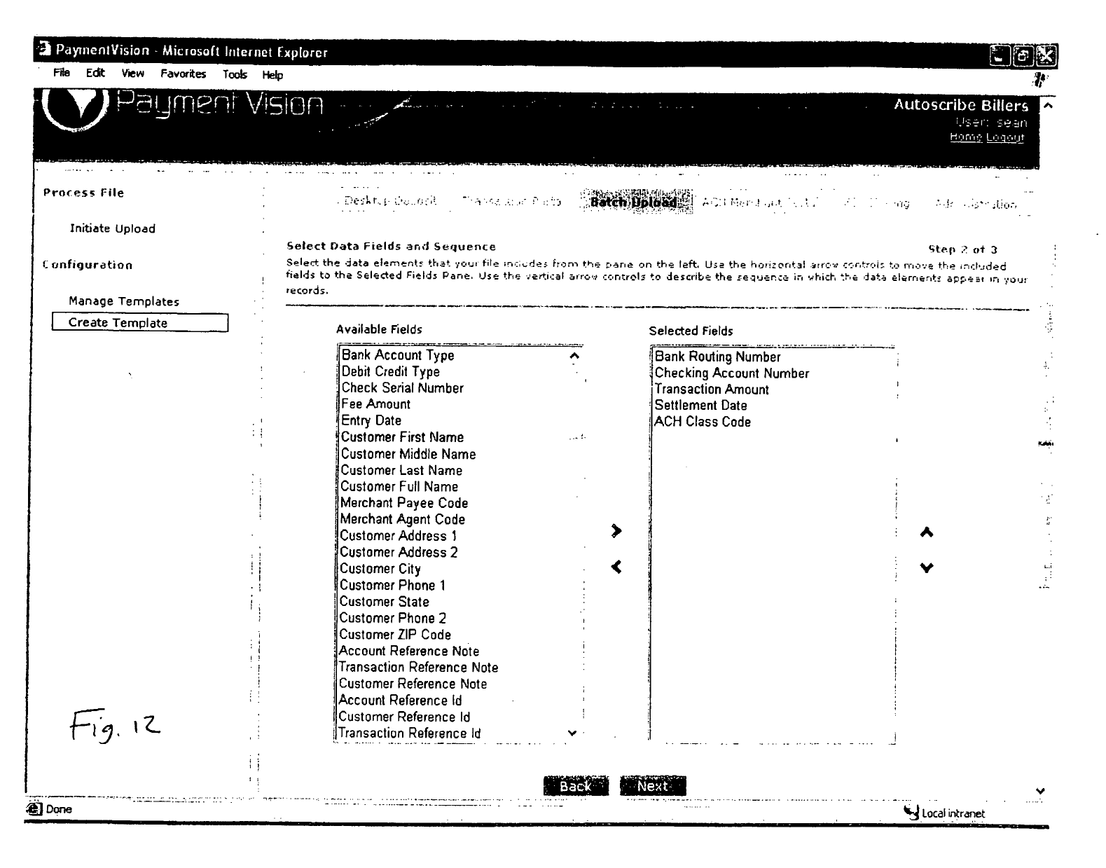

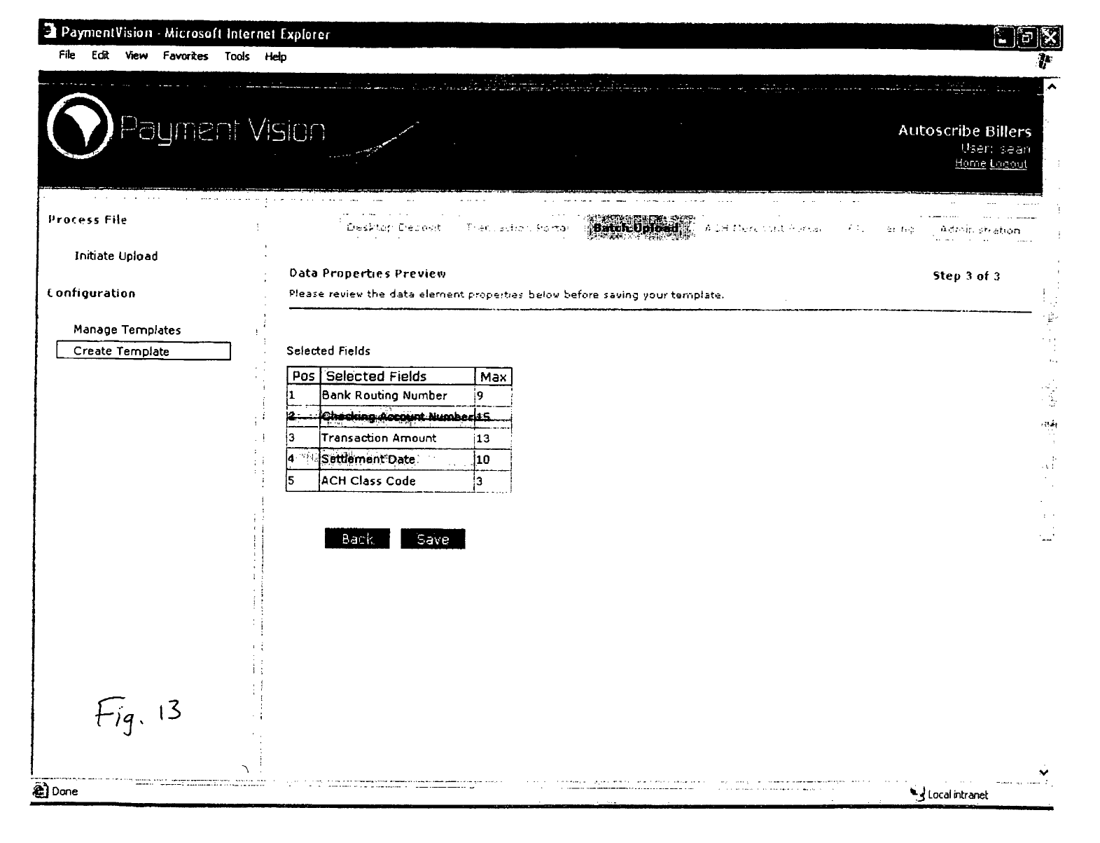

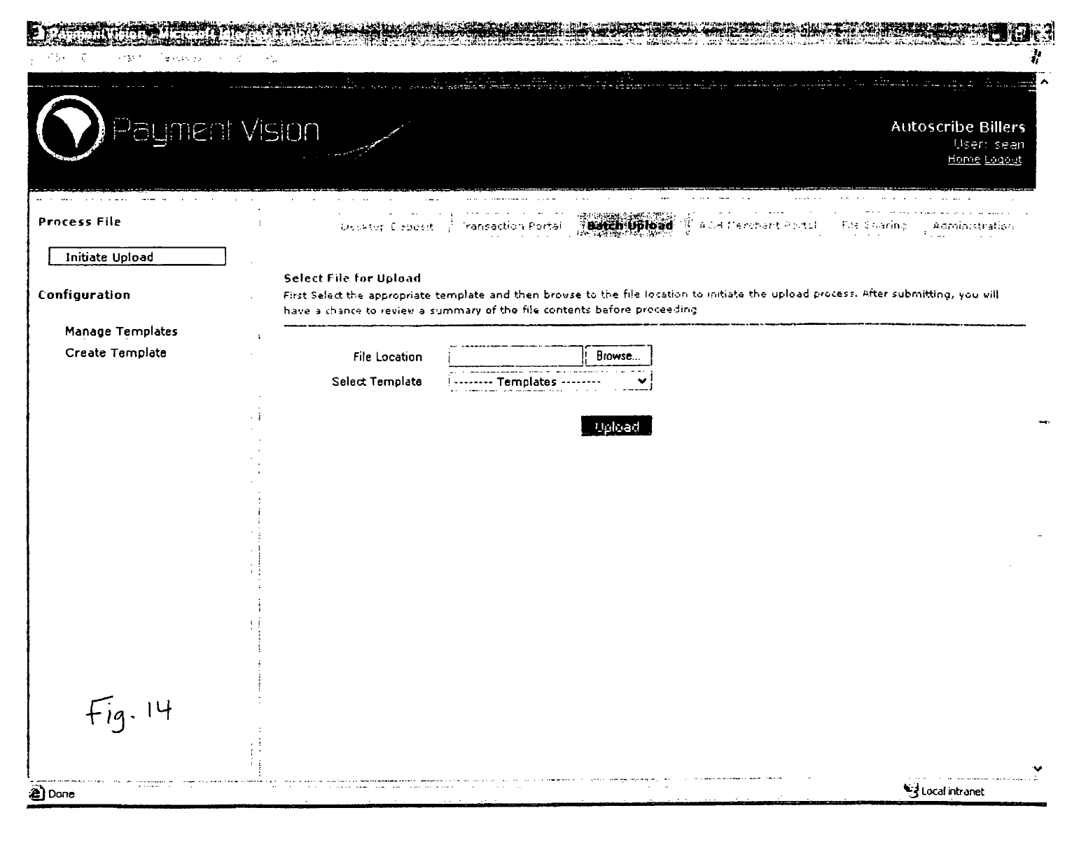

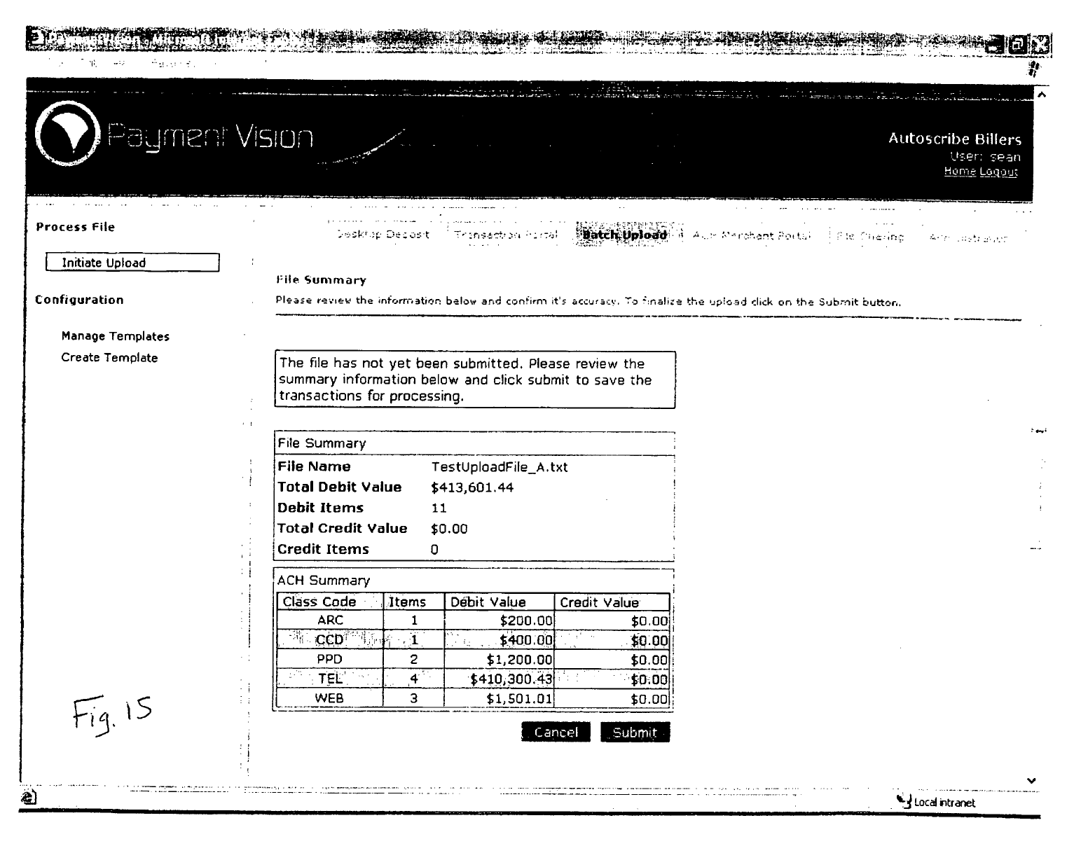

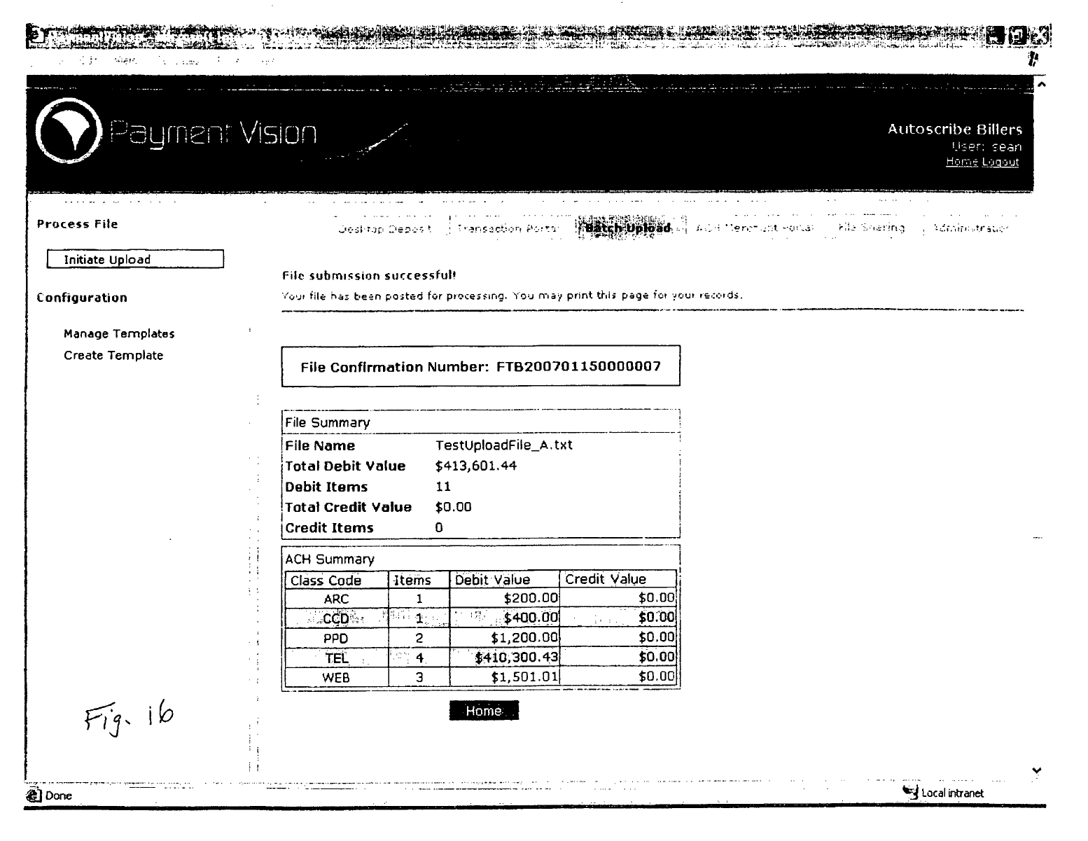

A user interface illustrating the implementation of this process is shown in FIGS. 10-16. FIG. 10 is an annotated example of a main screen for this process. FIGS. 11 through 16 show the steps implemented in the process for managing and selecting the matching of fields from the input file to a valid payment instruction format, the processing of the file, display of the results for the operator, and confirmation of the translation and upload.

In a further embodiment of the invention, an API or gateway is provided to make the processing rules engine described herein available to outside users processing payments through alternate methods. In this way, the system can be used to provide a service to other portals, internet shopping carts, vendors, etc. to access and use the transaction control rule system described above for their transactions. For example, in an embodiment, a Java applet may be used to provide a vendor neutral rules engine interface to external systems for risk assessment of their transactions.

In another embodiment, the system is provided with a process for verifying a routing number against a positive database and optionally querying a negative database of return data connected to the routing number/account number. This feature helps avoid repeated charges for submission of uncollectible payments. The ACH system, when it returns a payment as uncollectible, gives a reason for the return and this data can be recorded in a negative database for reference in processing future payments against that account. For example, if a payment is returned because the account is closed, it is virtually certain that future payments from that account will be dishonored and the system may be programmed to reject such payments. As another example, if payments have been returned for insufficient funds, the system may indicate an increased risk in submitting charges to that account, for consideration by a supervisor or further verification, but will not reject the payments since additional funds may have been deposited in the account.

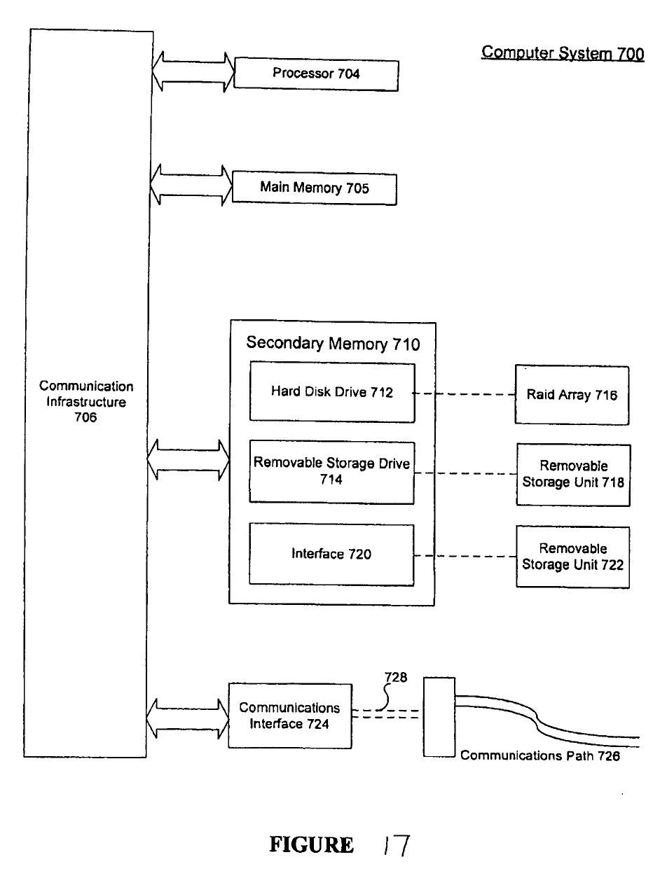

The following description of a general purpose computer system, such as a PC system, is provided as a non-limiting example of systems on which the disclosed processes can be performed. In particular, the methods disclosed herein can be performed manually, implemented in hardware, or implemented as a combination of software and hardware. Consequently, desired features of the invention may be implemented in the environment of a computer system or other processing system. An example of such a computer system 700 is shown in FIG. 17. The computer system 700 includes one or more processors, such as processor 704. Processor 704 can be a special purpose or a general purpose digital signal processor. The processor 704 is connected to a communication infrastructure 706 (for example, a bus or network). Various software implementations are described in terms of this exemplary computer system. After reading this description, it will become apparent to a person skilled in the relevant art how to implement the invention using other computer systems and/or computer architectures.

Computer system 700 also includes a main memory 705, preferably random access memory (RAM), and may also include a secondary memory 710. The secondary memory 710 may include, for example, a hard disk drive 712, and/or a RAID array 716, and/or a removable storage drive 714, representing a floppy disk drive, a magnetic tape drive, an optical disk drive, etc. The removable storage drive 714 reads from and/or writes to a removable storage unit 718 in a well known manner. Removable storage unit 718, represents a floppy disk, magnetic tape, optical disk, etc. As will be appreciated, the removable storage unit 718 includes a computer usable storage medium having stored therein computer software and/or data.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a PCMCIA slot and card, etc. Software and data transferred via communications interface 724 are in the form of signals 728 which may be electronic, electromagnetic, optical or other signals capable of being received by communications interface 724. These signals 728 are provided to communications interface 724 via a communications path 726. Communications path 726 carries signals 728 and may be implemented using wire or cable, fiber optics, a phone line, a cellular phone link, an RF link and other communications channels.

The terms “computer program medium” and “computer usable medium” are used herein to generally refer to media such as removable storage drive 714, a hard disk installed in hard disk drive 712, and signals 728. These computer program products are means for providing software to computer system 700.

Computer programs (also called computer control logic) are stored in main memory 408 and/or secondary memory 710. Computer programs may also be received via communications interface 724. Such computer programs, when executed, enable the computer system 700 to implement the present invention as discussed herein. In particular, the computer programs, when executed, enable the processor 704 to implement the processes of the present invention. Where the invention is implemented using software, the software may be stored in a computer program product and loaded into computer system 700 using raid array 716, removable storage drive 714, hard drive 712 or communications interface 724.

Although illustrative embodiments have been described herein in detail, it should be noted and understood that the descriptions and drawings have been provided for purposes of illustration only and that other variations both in form and detail can be added thereupon without departing from the spirit and scope of the invention. The terms and expressions have been used as terms of description and not terms of limitation. Thus, the breadth and scope of the present invention should not be limited by any of the above-described exemplary embodiments, but should be defined only in accordance with the following claims and their equivalents. The terms or expressions herein should not be interpreted to exclude any equivalents of features shown and described or portions thereof.

We claim:

1. A method for electronically processing payments made to a plurality of merchants in a plurality of payment modes, the method comprising:
(a) receiving information on the payments into a server;
(b) processing the information into an automated clearinghouse file;
(c) validating the automated clearinghouse file; and
(d) sending the automated clearinghouse file from the server to an automated clearinghouse.

2. The method of claim 1, wherein the plurality of payment modes comprise at least two of call center payments, Internet payments, IVR payments, and postal payments.

3. The method of claim 1, wherein step (b) comprises normalizing the information on the plurality of payment modes into a single data format.

4. The method of claim 3, wherein said normalizing comprises adaptively normalizing the information on the plurality of payment modes to accommodate known and unknown data formats.

5. The method of claim 1, wherein step (c) comprises performing an automated validation on the automated clearinghouse file.

6. The method of claim 5, further comprising authoring rules for the automated validation.

7. The method of claim 5, wherein step (c) further comprises providing the automated clearinghouse file to a user to review the automated validation.

8. The method of claim 1, wherein step (c) comprises providing the automated clearinghouse file to a user for review.

9. The method of claim 1, wherein step (b) comprises inserting tokens into the information on the payments and replacing the tokens dynamically with values specific to the payments as the information is processed into the automated clearinghouse file.

10. The method of claim 9, wherein the values specific to the payment are inserted into a description field that also includes a name of a payee.

11. The method of claim 1, wherein the merchants are organized into a plurality of merchant accounts and a plurality of sub-merchant accounts.

12. The method of claim 11, wherein the plurality of sub-merchant accounts are configured either to inherit characteristics of corresponding ones of the merchant accounts or to have customized characteristics.

13. The method of claim 12, further comprising providing a plurality of settlement accounts for the plurality of sub-merchants and disbursing the payments to the settlement accounts.

14. A system for electronically processing payments made to a plurality of merchants in a plurality of payment modes, the system comprising:
an input for receiving information on the payments into a server;
a processor for processing the information into an automated clearinghouse file and for validating the automated clearinghouse file; and
an output for sending the automated clearinghouse file from the server to an automated clearinghouse.

15. The system of claim 14, wherein the plurality of payment modes comprise at least two of call center payments, Internet payments, IVR payments, and postal payments.

16. The system of claim 14, wherein the processor normalizes the information on the plurality of payment modes into a single data format.

17. The system of claim 16, wherein the processor normalizes the data by normalizing the information on the plurality of payment modes to accommodate known and unknown data formats.

18. The system of claim 14, wherein the processor performs an automated validation on the automated clearinghouse file.

19. The system of claim 18, wherein the processor provides the automated clearinghouse file to a user to review the automated validation.

20. The system of claim 14, wherein the processor provides the automated clearinghouse file to a user for review.

21. The system of claim 14, wherein the processor inserts tokens into the information on the payments and replaces the tokens dynamically with values specific to the payments as the information is processed into the automated clearinghouse file.

22. The system of claim 21, wherein the values specific to the payment are inserted into a description field that also includes a name of a payee.

23. The system of claim 14, wherein the merchants are organized into a plurality of merchant accounts and a plurality of sub-merchant accounts.

24. The system of claim 23, wherein the plurality of sub-merchant accounts are configured either to inherit characteristics of corresponding ones of the merchant accounts or to have customized characteristics.
